(19) United States
(12) Patent Application Publication
(10) Pub. No.: US 2026/0238734 A1
(43) Pub. Date: Aug. 13, 2026

(54) IMAGE FORMING APPARATUS, METHOD FOR CONTROLLING IMAGE FORMING APPARATUS, AND NON-TRANSITORY COMPUTER-READABLE STORAGE MEDIUM STORING CONTROL PROGRAM OF IMAGE FORMING APPARATUS

(71) Applicant: SEIKO EPSON CORPORATION, Tokyo (JP)

(72) Inventor: Tomoki MAEKAWA, Shiojiri (JP)

(21) Appl. No.: 19/395,590

(22) Filed: Nov. 20, 2025

(30) Foreign Application Priority Data
Nov. 22, 2024 (JP) 2024-203630

(51) Int. Cl. H04N 1/44

(52) U.S. Cl. CPC H04N 1/4426; H04N 1/4413; H04N 1/4433; H04N 2201/0094

(57) ABSTRACT

An image forming apparatus includes a generation section that generates authentication information, a transmission section that transmits the authentication information to a terminal device, a reception section that receives input authentication information input to a user interface section of the image forming apparatus, and an authentication section that performs user authentication based on the input authentication information and the authentication information.

The present application is based on, and claims priority from JP Application Serial Number 2024-203630, filed Nov. 22, 2024, the disclosure of which is hereby incorporated by reference herein in its entirety.

### BACKGROUND

### 1. Technical Field

The present disclosure relates to an image forming apparatus, a method for controlling the image forming apparatus, and a non-transitory computer-readable storage medium storing a control program of the image forming apparatus.

### 2. Related Art

JP-A-2015-22619 describes a technique of logging in to an image forming apparatus by inputting a PIN code.

However, in the related art, a server for PIN generation is required to be installed separately from the image forming apparatus.

### SUMMARY

According to an aspect of the present disclosure, an image forming apparatus includes a generation section that generates authentication information, a transmission section that transmits the authentication information to a terminal device, a reception section that receives input authentication information input to a user interface section of the image forming apparatus, and an authentication section that performs user authentication based on the input authentication information and the authentication information.

According to another aspect of the present disclosure, a method for controlling an image forming apparatus causes the image forming apparatus to generate authentication information, transmit the authentication information to a terminal device, receive input authentication information input to a user interface section of the image forming apparatus, and perform user authentication based on the input authentication information and the authentication information.

According to a further aspect of the present disclosure, a non-transitory computer-readable storage medium stores a control program of an image forming apparatus that causes a computer to function as a generation section that generates authentication information, a transmission section that transmits the authentication information to a terminal device, a reception section that receives input authentication information input to a user interface section of the image forming apparatus, and an authentication section that performs user authentication based on the input authentication information and the authentication information.

### BRIEF DESCRIPTION OF THE DRAWINGS

FIG. 1 is a block diagram illustrating a configuration of a multifunction peripheral.

FIG. 2 is a diagram illustrating an example of user information.

FIG. 3 is a diagram illustrating an example of a screen switch.

FIG. 4 is a diagram illustrating an example of a screen switch.

FIG. 5 is a flowchart of a user authentication process.

### DESCRIPTION OF EMBODIMENTS

Here, embodiments of the present disclosure will be described in the following order.
1. Configuration of Multifunction Peripheral
2. User Authentication Process
3. Other Embodiments
1. Configuration of Multifunction Peripheral

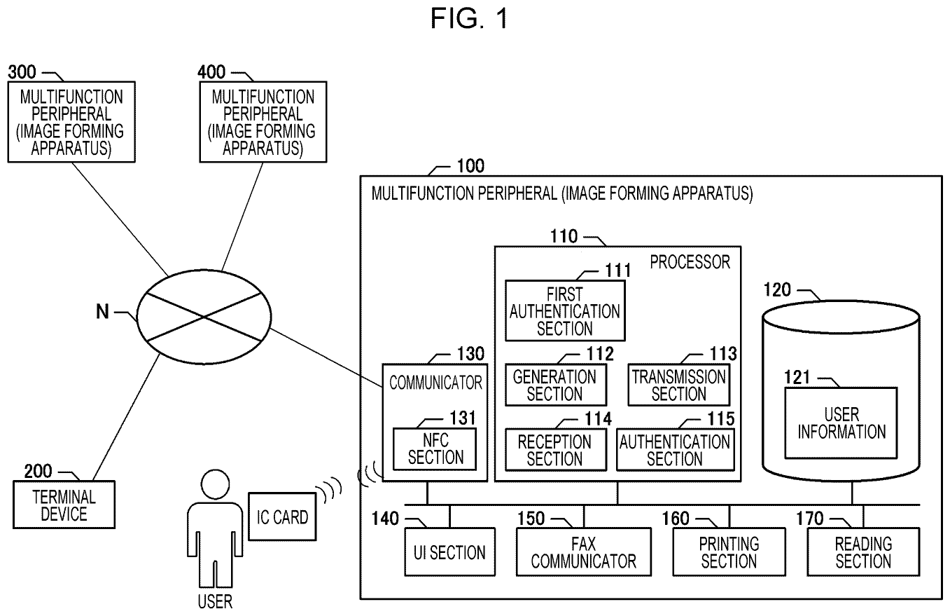

FIG. 1 is a block diagram illustrating a configuration of a multifunction peripheral 100 as an image forming apparatus according to an embodiment of the present disclosure. The multifunction peripheral 100 cooperates with a terminal device 200. The terminal device 200 is a terminal used by a user of the multifunction peripheral 100, and may be a PC, a tablet, a smartphone, or the like.

In this embodiment, it is assumed that the multifunction peripheral 100 is installed in an office of a company. Employees working in the office are permitted to use the multifunction peripheral 100, and IC cards indicating that the employees are permitted to use the multifunction peripheral 100 are individually given to the permitted users. The IC cards have respective storage media storing respective card IDs for identifying the IC cards. Furthermore, user IDs are assigned to the individual users.

In this embodiment, a user of the multifunction peripheral 100 can log in to the multifunction peripheral 100 and use the multifunction peripheral 100 by holding an IC card owned by the user over the multifunction peripheral 100 for authentication using a PIN described below.

The multifunction peripheral 100 includes a processor 110, a storage medium 120, a communicator 130, a UI section 140, a FAX communicator 150, a printing section 160, and a reading section 170. The processor 110 includes a CPU, a ROM, a RAM, and the like (not illustrated), and can control the individual sections of the multifunction peripheral 100 by executing a control program recorded in the storage medium 120. Note that the processor 110 may be constituted by a single chip or a plurality of chips. Furthermore, for example, an ASIC may be employed instead of the CPU, or the CPU and the ASIC may cooperate with each other. When each of the devices according to this embodiment includes a processor, the processor may be realized in various forms, similarly to the processor 110.

The communicator 130 includes various communication interfaces for communicating with other devices in a wired or wireless manner. Note that the communicator 130 includes an interface for communicating with various removable memories mounted on the multifunction peripheral 100, and printing and FAX transmission of data recorded in the removable memories, saving of scan data in the removable memories, and the like are enabled.

In this embodiment, the communicator 130 includes a near field communication (NFC) section 131. The NFC section 131 has a function of acquiring data recorded in a recording medium of an IC card by communicating with the IC card when the IC card including an IC chip or an antenna corresponding to short-range wireless communication approaches within a predetermined distance.

The UI section 140 as a user interface section includes a touch panel display, keys, an LED, and a speaker. The processor 110 announces various types of information to a user by an output section, such as the touch panel display, the LED, or the speaker, and accepts an instruction of the user via an input section, such as the touch panel display or the keys.

The FAX communicator 150 includes a modem for performing FAX communication of image data via a public switched telephone network or the like, a circuit for detecting and generating a control signal for transmitting and receiving the image data, and a circuit for encoding transmission data and decoding reception data. The printing section 160 includes a driving section, a mechanical component, and a sensor for executing printing on various printing media by various printing methods, such as an ink jet method and an electrophotographic method. The reading section 170 includes a device for reading a document mounted on a document table glass or a document set on an ADF document tray. Examples of the device include an image sensor, a light source, a driving section for reading a document, a mechanical component, a sensor, and the like.

As described above, each user of the multifunction peripheral 100 carries an IC card indicating that use of the multifunction peripheral 100 is permitted and capable of performing the above-described communication with the NFC section 131. A card ID for identifying the card is recorded in a recording medium of the IC card.

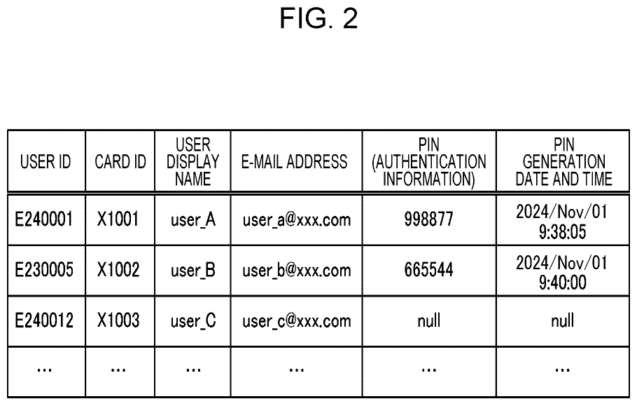

The storage medium 120 stores user information 121. FIG. 2 is a diagram illustrating an example of the user information 121. In the user information 121, a card ID of an IC card given to a user, a user display name, and an e-mail address are stored in association with a user ID for identifying the user. When a personal identification number (PIN) is generated as authentication information in an operation process of the multifunction peripheral 100, the PIN and a date and time of the generation of the PIN are stored. Note that the PIN is invalidated by being discarded from the user information 121 by the processor 110 when a predetermined period of time has elapsed after the PIN is generated. In FIG. 2, “null” illustrated in a PIN column indicates that a valid PIN is not stored.

The processor 110 of the multifunction peripheral 100 can execute a control program for realizing a function of transmitting authentication information generated by the multifunction peripheral 100 to the terminal device 200 of the user. By executing the control program, the processor 110 functions as a first authentication section 111, a generation section 112, a transmission section 113, a reception section 114, and an authentication section 115.

The processor 110 performs first authentication by the first authentication section 111. In this embodiment, the first authentication is performed using the IC card before authentication using the PIN is performed. When a user holds an IC card over the NFC section 131, the processor 110 acquires a card ID stored in the IC card by the NFC section 131. When a user ID corresponding to the card ID recorded in the IC card is stored in the user information 121, the processor 110 determines that the first authentication has been successfully performed.

In this embodiment, when the first authentication has been successfully performed, the processor 110 generates authentication information by the generation section 112. In this embodiment, the authentication information is a PIN code represented by a 6-digit number. The generation section 112 of the processor 110 generates, as a PIN, a random 6-digit number which is different from already issued and valid 6-digit numbers or invalid 6-digit numbers issued for, for example, several days in the past. As illustrated in FIG. 2, the processor 110 stores the PIN and the date and time of the generation of the PIN in association with the user ID of the user authenticated by the first authentication.

Furthermore, the transmission section 113 of the processor 110 transmits the generated PIN to the terminal device 200. That is, the processor 110 transmits the PIN to the terminal device 200 based on the user information of the user authenticated by the first authentication. More specifically, the processor 110 transmits an e-mail including, in text, the PIN issued to the user authenticated by the first authentication to an e-mail address stored in association with the user. Since the user confirms the e-mail on the terminal device 200, the processor 110 finally transmits the PIN to the terminal device 200.

The user who has confirmed the e-mail on the terminal device 200 of the user inputs the PIN to the UI section 140 of the multifunction peripheral 100. The input PIN is input authentication information. The reception section 114 of the processor 110 receives the PIN as the input authentication information input to the UI section 140 of the multifunction peripheral 100.

The authentication section 115 of the processor 110 performs user authentication based on the input authentication information and the authentication information. That is, the processor 110 determines whether the PIN received by the reception section 114 matches the PIN generated by the generation section 112 and stored in association with the user ID. In a case where it is determined that the two match each other, the processor 110 determines that the authentication has been successfully performed, and sets a state in which various functions, such as a FAX function, a copy function, a print function, and a scan function, of the multifunction peripheral 100 may be used, that is, a login state. As described above, when the input authentication information matches the authentication information, the multifunction peripheral 100 can enter the state in which the authenticated user has logged in to the multifunction peripheral 100, and the user may use the functions of the multifunction peripheral 100.

As described above, the processor 110 performs the first authentication using an IC card and then performs the authentication using the PIN. That is, authentication can be performed in two stages. Therefore, according to this embodiment, it is possible to enhance security in the multifunction peripheral 100. Furthermore, according to this embodiment, since the multifunction peripheral 100 itself can generate authentication information and notify the terminal device 200 of the authentication information, a server for generating the authentication information is not required to be separately installed.

Note that the generation section 112 of the processor 110 invalidates the PIN as the authentication information when a predetermined period of time has elapsed after the PIN is generated. Specifically, for example, after generating the PIN and storing the PIN in association with the user ID, the processor 110 counts an elapsed period of time from a PIN generation date and time, and when the predetermined period of time has elapsed from the PIN generation date and time, discards the PIN and the PIN generation date and time stored in association with the user ID. In a case where the PIN is discarded after the predetermined period of time, even when the PIN is input to the UI section 140 of the multifunction peripheral 100 after the predetermined period of time, that is, after the PIN becomes invalid, the processor 110 does not consider that the authentication has been successfully performed, and does not cause the multifunction peripheral 100 to be switched to a login state of the user associated with the PIN. Therefore, it is possible to reduce a possibility that the authentication information is used by another person and the other person pretends to be the user and logs in.

In this embodiment, the e-mail transmitted to the terminal device 200 includes information other than the PIN. That is, the transmission section 113 of the processor 110 transmits identification information for identifying the multifunction peripheral 100 to the terminal device together with the PIN as the authentication information. The identification information of the multifunction peripheral 100 is, for example, a device ID, an IP address, or the like. For example, a sticker on which the identification information of the multifunction peripheral 100 is printed is attached to a housing of the multifunction peripheral 100, or the identification information of the multifunction peripheral 100 is displayed on a standby screen of the multifunction peripheral 100, so that the user can identify the multifunction peripheral 100 indicated by the identification information.

For example, as illustrated in FIG. 1, it is assumed that a plurality of multifunction peripherals having a function of issuing a PIN and transmitting the PIN to the terminal device 200 of the user similarly to the multifunction peripheral 100 are installed in an office. FIG. 1 represents a case where multifunction peripherals 300 and 400 are installed in an office in addition to the multifunction peripheral 100. In this case, a single user may use the plurality of multifunction peripherals 100, 300, and 400 in parallel. In this situation, since PINs and identification information of the individual multifunction peripherals are included in e-mails transmitted from the individual multifunction peripherals to the terminal device 200 of the user, the user can recognize the multifunction peripherals which have generated the PINs and the multifunction peripherals to which the PINs are supplied.

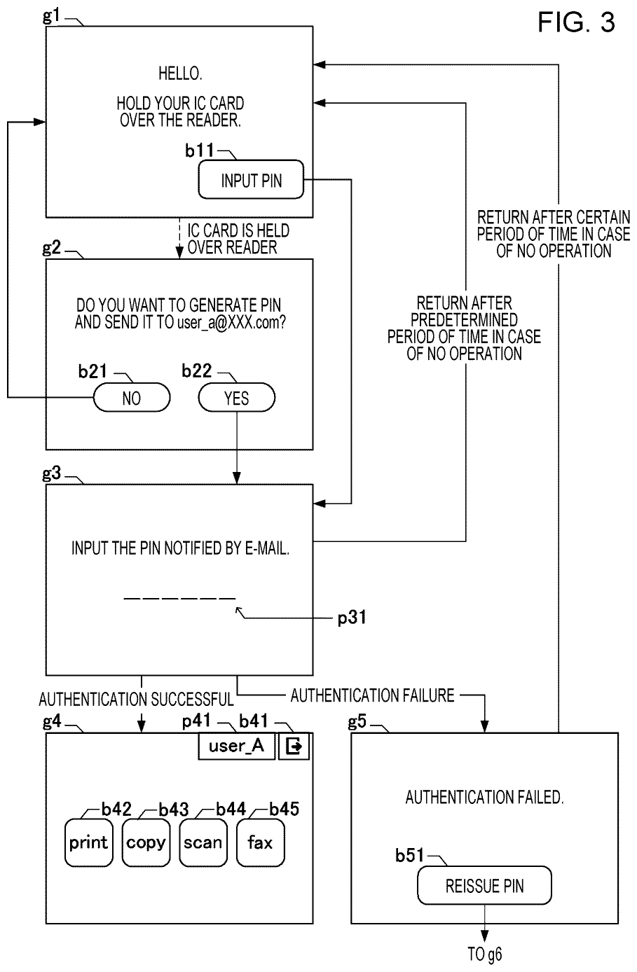

FIG. 3 is a diagram illustrating an example of a screen switch of the multifunction peripheral 100. Here, g1 indicates a standby screen displayed before any user logs in. When the standby screen g1 is displayed on the UI section 140, the multifunction peripheral 100 is in a state in which all users have logged out from the multifunction peripheral 100. Also in the multifunction peripherals 300 and 400, the standby screen g1 is displayed on a UI section before any user logs in. Note that the standby screen g1 includes a PIN input button b11.

When a user holds the IC card of the user over the NFC section 131 of the multifunction peripheral 100 in the state where the standby screen g1 is displayed, the processor 110 performs the first authentication as described above, and displays a PIN issuance confirmation screen g2 on the UI section 140 of the multifunction peripheral 100 in a case where the first authentication is successfully performed. The first authentication success indicates that a user ID corresponding to a card ID can be specified. The PIN issuance confirmation screen g2 is used to obtain permission from the user to generate a PIN and transmit the PIN to an e-mail address associated with the specified user ID. When receiving the permission from the user, that is, pressing of a “Yes” button b22, the processor 110 generates a PIN and transmits the PIN by the e-mail. Then, in this embodiment, the processor 110 displays a PIN input screen g3 on the UI section 140 of the multifunction peripheral 100. Then, when transmitting the e-mail including the PIN, the processor 110 displays the PIN input screen g3 on the UI section 140 for a predetermined period of time. In a case where the terminal device 200 is a portable device, the user can immediately check the e-mail on the terminal device 200 in front of the multifunction peripheral 100, recognize the PIN, and input the PIN on the PIN input screen g3 within the predetermined period of time. Note that, in a case where a state in which a PIN is not input to the UI section 140 continues for the predetermined period of time after the PIN input screen g3 is displayed, the processor 110 switches the display of the UI section 140 to the standby screen g1 after the predetermined period of time elapses.

When the terminal device 200 is not a portable terminal, the user moves from an installation location of the multifunction peripheral 100 to an installation location of the terminal device 200, checks the e-mail, writes the PIN included in the e-mail in a memory or on paper, and returns to the multifunction peripheral 100, and therefore, the user who has completed the first authentication may temporarily leave the multifunction peripheral 100. During a period of time in which the user who has completed the first authentication is away from the multifunction peripheral 100, a situation in which another user wants to use the multifunction peripheral 100 is also assumed. Therefore, in this embodiment, the PIN input screen g3 is switched to the standby screen g1 when the predetermined period of time has elapsed without input of a PIN.

In the following description, a user who has completed the first authentication and is away from the multifunction peripheral 100 is referred to as a first user, and another user who attempts to perform the first authentication on the multifunction peripheral 100 while the first user is away is referred to as a second user. The second user can perform the first authentication by holding an IC card of the user over the NFC section 131 while the standby screen g1 is being displayed. That is, in this embodiment, when the number of users is less than a predetermined upper limit, the multifunction peripheral 100 can store PINs issued to a plurality of users and wait for PIN inputs by the plurality of users.

Note that the order of users who have performed the first authentication and the users who perform the authentication using the PIN may not be the same. For example, the second user may log in by inputting the PIN and use the functions of the multifunction peripheral 100 before the first user. When a PIN that matches any of the issued valid PINs is input, the processor 110 regards a user corresponding to the input PIN as having been successfully authenticated, and switches to a state in which the user has logged in.

As described above, the standby screen g1 includes the PIN input button b11. The PIN input button b11 is a button for displaying the PIN input screen g3 without the user who has already completed the first authentication holding the IC card over the NFC section 131 again. Therefore, the user who has completed the first authentication can display the PIN input screen g3 by the PIN input button b11 provided on the standby screen g1 without performing the first authentication again, and can input the PIN on the PIN input screen g3. Furthermore, in this embodiment, since the PIN input screen g3 is displayed for a predetermined period of time after the PIN is generated and an e-mail is transmitted, the user can input the PIN on the PIN input screen g3 without performing an operation for displaying the PIN input screen g3 during the predetermined period of time.

When the PIN is input on the PIN input screen g3, the processor 110 determines whether the input PIN matches any of the stored valid PINs. When it is determined that the two match each other, a state in which the user has logged in by a user ID corresponding to the matched PIN is entered. A reference symbol g4 in FIG. 3 denotes an example of a user home screen of user_A, which illustrates a state in which user_A has logged in. The user home screen g4 includes a user name display portion p41 of the user who has logged in, and a logout button b41 for the user who has logged in to log out. In addition, the user home screen g4 includes buttons b42, b43, b44, and b45 for using the functions of the multifunction peripheral 100. For example, when the print button b42 is pressed, the screen is switched to a screen for selecting a file to be printed and performing various print settings, such as a number-of-copies setting, a paper size setting, an allocation setting, a double-sided printing setting, and a color setting.

When the PIN input on the PIN input screen g3 does not match any of the stored valid PINs, the processor 110 displays an authentication failure screen g5 on the UI section 140 of the multifunction peripheral 100. The authentication failure screen g5 is a screen for displaying a message indicating that authentication has failed because the input PIN does not match any of the issued valid PINs. By displaying this message, the multifunction peripheral 100 can cause the user to recognize that the authentication has failed and the user may not log in.

In this embodiment, the authentication failure screen g5 includes a PIN reissue button b51. When the PIN reissue button b51 is pressed, the processor 110 causes the generation section 112 to regenerate a PIN and causes the transmission section 113 to retransmit the regenerated PIN to the terminal device 200. Use cases leading to the PIN reissue include a case where the user deletes the e-mail notifying the PIN, and a case where a validity period of the PIN notified by the e-mail expires and the PIN becomes invalid.

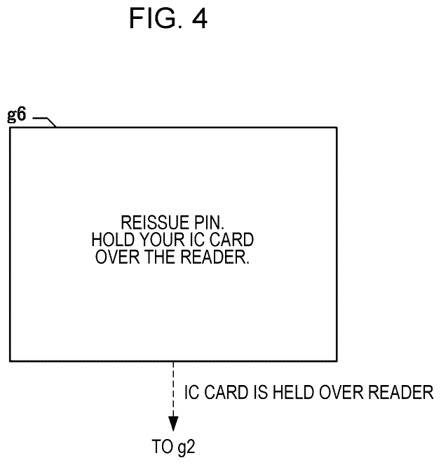

In this embodiment, when the PIN reissue button b51 is pressed, the processor 110 displays a pre-reissue screen go illustrated in FIG. 4 on the UI section 140. The pre-reissue screen g6 includes a message prompting the user to hold the IC card over the NFC section 131 in order to reissue the PIN. When the IC card is held over the NFC section 131 of the multifunction peripheral 100 in a state where the pre-reissue screen g6 is displayed, the processor 110 acquires a card ID from the IC card and specifies a user ID corresponding to the card ID based on the user information 121. Then, the processor 110 displays the PIN issuance confirmation screen g2, and when PIN generation and e-mail transmission are permitted on the PIN issuance confirmation screen g2, a PIN is regenerated and stored in association with the specified user ID. In a case where a PIN within an expiration date is stored in association with the user ID, the processor 110 overwrites the PIN with the regenerated new PIN and also overwrites a generation date and time with a regeneration date and time. In addition, the processor 110 transmits an e-mail including the regenerated new PIN to the e-mail address corresponding to the specified user ID. With this configuration, in a case where the authentication using a PIN fails, the processor 110 can cause the user to try the authentication again using a regenerated new PIN.

### 2. User Authentication Process

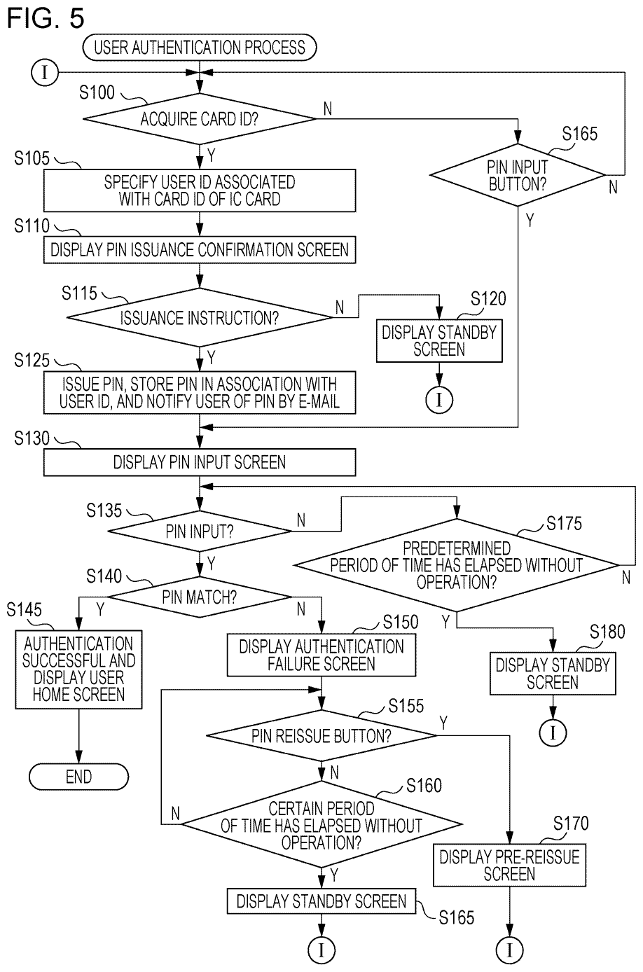

FIG. 5 is a flowchart illustrating the user authentication process. A flow of the user authentication process will be described with reference to screen switch examples illustrated in FIGS. 3 and 4. The user authentication process illustrated in FIG. 5 is started in a state where the standby screen g1 illustrated in FIG. 3 is displayed on the UI section 140 of the multifunction peripheral 100. When the standby screen g1 is displayed on the UI section 140, the multifunction peripheral 100 is in a state in which all users have logged out from the multifunction peripheral 100. The standby screen g1 is a screen for prompting a user to hold an IC card over the NFC section 131.

When the user holds the IC card over the NFC section 131 in a state where the standby screen g1 is displayed, the processor 110 acquires a card ID from the IC card via the NFC section 131. The processor 110 causes the first authentication section 111 to determine whether the card ID has been acquired (step S100). When it is determined that the card ID has been acquired, the processor 110 specifies a user ID associated with the card ID of the IC card (step S105). That is, the processor 110 refers to the user information 121 and specifies the user ID associated with the card ID.

Subsequently, the processor 110 displays the PIN issuance confirmation screen g2 (step S110). The processor 110 determines whether an issuance has been instructed on the PIN issuance confirmation screen g2 (step S115), and when it is not determined that an issuance has been instructed, that is, when a “No” button b21 is pressed, the processor 110 displays the standby screen g1 (step S120) and the process returns to step S100.

When it is determined in step S115 that an issuance has been instructed, that is, when the “Yes” button b22 is pressed, the processor 110 issues a PIN, stores the PIN in the storage medium 120 in association with the user ID, and notifies the user of the PIN by an e-mail (step S125). That is, the processor 110 causes the generation section 112 to generate a random 6-digit number, and stores the number in association with the user ID specified in step S105. Furthermore, the processor 110 causes the transmission section 113 to generate an e-mail including the generated PIN and the identification information of the multifunction peripheral 100 and transmit the e-mail to an e-mail address corresponding to the user ID. In addition, the processor 110 acquires a current date and time when the PIN is issued from a clocking circuit (not illustrated) and stores the generation date and time. The processor 110 separately executes a process of invalidating the PIN generated at the generation date and time when a predetermined period of time has elapsed from the generation date and time.

Subsequently, the processor 110 displays the PIN input screen g3 (step S130). The PIN input screen g3 is a screen for prompting the user to input the issued 6-digit number. Subsequently, the processor 110 causes the reception section 114 to determine whether a PIN has been input (step S135). That is, it is determined whether a 6-digit number has been input on the PIN input screen g3. A numeric keypad for inputting numbers is displayed, for example, in the PIN input screen g3.

When it is determined in step S135 that the PIN has been input, the processor 110 causes the authentication section 115 to determine whether the PINs match each other (step S140). That is, it is determined whether the PIN as the authentication information issued in step S125 and the PIN as the input authentication information acquired via the UI section 140 in step S135 match each other.

When it is determined in step S140 that the two match each other, the processor 110 determines that the authentication is successfully performed, and displays the user home screen g4 (step S145). When it is not determined in step S140 that the two match each other, the processor 110 displays the authentication failure screen g5 (step S150).

In this embodiment, the authentication failure screen g5 includes the PIN reissue button b51. The processor 110 determines whether the PIN reissue button b51 has been pressed (step S155). When it is determined in step S155 that the PIN reissue button b51 has been pressed, the processor 110 displays the pre-reissue screen g6 illustrated in FIG. 4 (step S170), and the process returns to step S100.

When it is not determined in step S155 that the PIN reissue button b51 has been pressed, the processor 110 determines whether a certain period of time has elapsed without any operation (step S160). When it is not determined that the certain period of time has elapsed, the process returns to step S155. When it is determined in step S160 that the certain period of time has elapsed, the processor 110 displays the standby screen g1 (step S165) and the process returns to step S100.

When it is not determined in step S135 that the PIN has been input, the processor 110 determines whether a predetermined period of time has elapsed without any operation (step S175). When it is determined in step S175 that the predetermined period of time has elapsed, the processor 110 displays the standby screen g1 (step S180) and the process returns to step S100. When the processor 110 does not determine in step S175 that the predetermined period of time has elapsed, the process returns to step S135.

In step S100, when it is not determined that the card ID has been acquired, the processor 110 determines whether the PIN input button b11 has been pressed on the standby screen g1 (step S165). When the processor 110 determines in step S165 that the PIN input button b11 has been pressed, the process proceeds to step S130 and the processor 110 displays the PIN input screen g3. When the processor 110 does not determine in step S165 that the PIN input button b11 has been pressed, the process returns to step S100.

### 3. Other Embodiments

The above embodiment is an example for embodying the present disclosure, and various other embodiments may be adopted. For example, in the above-described embodiment, an example in which the image forming apparatus is configured as a multifunction peripheral having an image forming function, an image reading function, and a FAX transmission/reception function has been described, but the present disclosure is not limited to this aspect. Whether the image forming apparatus has a function other than the image forming function is arbitrary. It may be assumed that the image forming apparatus is used in various organizations, such as schools in addition to companies.

In the above-described embodiment, authentication using an IC card has been described as the first authentication. However, for example, authentication using a user ID and a password may be employed as the first authentication. In addition, both the authentication using the IC card and the authentication using the user ID may be available, and the user may select one of the authentications each time.

The screen switches and the screen configuration described in the above embodiment are merely examples, and the present disclosure is not limited thereto. For example, the PIN issuance confirmation screen g2 may be omitted. Furthermore, in the above-described embodiment, when the authentication information is transmitted, the PIN input screen g3 is displayed for a predetermined period of time, the PIN input screen g3 is switched to the standby screen g1 including the PIN input button b11 after the predetermined period of time has elapsed, and the standby screen g1 is switched to the PIN input screen g3 when the PIN input button b11 of the standby screen g1 is pressed. However, the standby screen g1 may be displayed immediately after a PIN notification mail is transmitted. For example, when the “Yes” button b22 on the PIN issuance confirmation screen g2 in FIG. 3 is pressed, the screen may be immediately switched to the standby screen g1 without displaying the PIN input screen g3.

Furthermore, the PIN reissue button b51 may be provided, for example, on the PIN input screen illustrated as g3 in FIG. 3.

The transmission section may transmit the authentication information to the terminal device used by the user to notify the user of the authentication information. Instead of the e-mail, the notification may be performed by a short message, a chat application, a talk application, or the like. In this case, the user information includes information on a destination in each notification mode corresponding to the user so that the notification can be performed in each mode. Furthermore, it is sufficient that the user notified of the authentication information can input the authentication information to the image forming apparatus, and a form of the authentication information may be text data, image data, such as a two dimensional code or a barcode, or voice data. In a case where the notification is made by a two dimensional code or a barcode, the image forming apparatus includes a reader for reading a two dimensional code or a barcode and a decoding module for a two dimensional code or a barcode. In a case of voice data, the user may listen to voice and manually input authentication information indicated by the voice to the image forming apparatus.

In addition, the present disclosure may also be applied as a program or a method executed by a computer. For example, the above-described contents may also be applied as a disclosure of a method for controlling an image forming apparatus including generating authentication information, transmitting the authentication information to a terminal device, receiving input authentication information input to a user interface section of the image forming apparatus, and performing user authentication based on the input authentication information and the authentication information. In addition, the above-described contents may also be applied as a disclosure of a control program of an image forming apparatus that causes a computer to function as a generation section that generates authentication information, a transmission section that transmits the authentication information to a terminal device, a reception section that receives input authentication information input to a user interface section of the image forming apparatus, and an authentication section that performs user authentication based on the input authentication information and the authentication information.

Furthermore, the system, the program, and the method described above may be realized as a single device or may be realized by using components included in a plurality of devices, and various forms thereof are included. Moreover, the configuration can be appropriately changed in such a manner that a portion of the configuration is software and a portion of the configuration is hardware. In addition, the disclosure may also be realized as a recording medium for recording a program for controlling the system. Undoubtedly, the recording medium for the program may be a magnetic recording medium or a semiconductor memory, and any recording medium to be developed in the future may be considered in the same manner.

What is claimed is:

1. An image forming apparatuses, comprising:
a generation section that generates authentication information;
a transmission section that transmits the authentication information to a terminal device;
a reception section that receives input authentication information input to a user interface section of the image forming apparatus; and
an authentication section that performs user authentication based on the input authentication information and the authentication information.

2. The image forming apparatus according to claim 1, further comprising
a first authentication section that performs first authentication different from authentication based on the authentication information, wherein
the generation section generates the authentication information when the first authentication is successfully performed, and
the transmission section transmits the authentication information to the terminal device based on user information of a user authenticated by the first authentication.

3. The image forming apparatus according to claim 2, wherein
the transmission section transmits, to the terminal device, identification information of the image forming apparatus together with the authentication information.

4. The image forming apparatus according to claim 2, wherein
the reception section causes a switch to a standby screen including an input button when the authentication information is transmitted, and causes a switch to an input screen of the input authentication information when the input button is pressed on the standby screen.

5. The image forming apparatus according to claim 4, wherein
when the authentication information is transmitted, the reception section displays the input screen on the user interface section for a predetermined period of time and causes a switch to the standby screen after the predetermined period of time elapses.

6. The image forming apparatus according to claim 1, wherein
the generation section invalidates the authentication information when a predetermined period of time elapses after generation of the authentication information.

7. The image forming apparatus according to claim 1, wherein
when the input authentication information and the authentication information match each other, the authentication section determines that the authentication is successfully performed, and functions of the image forming apparatus are enabled.

8. The image forming apparatus according to claim 1, wherein
when the input authentication information and the authentication information do not match each other, the authentication section displays a message indicating a failure of the authentication on the user interface section.

9. The image forming apparatus according to claim 1, wherein
the generation section regenerates authentication information when a reissue button displayed on the user interface section is pressed, and
the transmission section transmits, to the terminal device, the authentication information regenerated.

10. A method for controlling an image forming apparatus, the method causing the image forming apparatus to:
generate authentication information;
transmit the authentication information to a terminal device;
receive input authentication information input to a user interface section of the image forming apparatus; and
perform user authentication based on the input authentication information and the authentication information.

11. A non-transitory computer-readable storage medium storing a control program of an image forming apparatus, the control program causing a computer to function as:
a generation section that generates authentication information;
a transmission section that transmits the authentication information to a terminal device;
a reception section that receives input authentication information input to a user interface section of the image forming apparatus; and
an authentication section that performs user authentication based on the input authentication information and the authentication information.
